(19) United States
(12) Patent Application Publication
(10) Pub. No.: US 2010/0141039 A1
(43) Pub. Date: Jun. 10, 2010

(54) HIGH AVAILABILITY, HIGH EFFICIENCY DATA CENTER ELECTRICAL DISTRIBUTION

(75) Inventors: Christian L. Belady, Mercer Island, WA (US); Scott Thomas Seaton, Kirkland, WA (US); Sean Michael James, Olympia, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/355,818

(22) Filed: Jan. 19, 2009

(51) Int. Cl. H02J 9/00

(52) U.S. Cl. 307/68; 307/64

(57) ABSTRACT

Unlike symmetric power feeds for dual-corded server environments, an asymmetrical power system for high availability environments uses an imbalanced power feed system, allowing lower cost implementation and, in some cases, reduced energy loss in the primary power supply path. One asymmetric power feed uses a direct power feed to supply normal operating power and uses a second system to supply back up power via a switched, conditioned, path with UPS and generator. Because the main power delivery is through the direct line, reliability and power loss are improved.

### BACKGROUND

Data centers, server farms, and other high availability environments require consistent power to maintain operation. Such environments typically include power from two or more independent sources and servers/server racks typically have two cords so that power can be supplied from either or both sources.

Each independent source often includes power conditioning, uninterruptible power supplies, generators, etc., to guarantee supply of power. Known implementations use symmetrical arrangements so that both sources supply equal power during normal operation and either source can supply all the required power during an outage or a failure in one source.

As shown in prior art FIG. 1, a data center 10 is shown with server or servers 16 that have dual power cords 18 and 20. A first power supply path, illustrated on the left side of the drawing, includes a transformer 22 representing a power company connection. A generator 24 is coupled to switch gear 26 for switching power between the transformer 22 and the generator 24 as required. An uninterruptible power supply (UPS) 28 can supply power either via the switch gear 26 or from an internal source, such as batteries and an inverter (not depicted). Mechanical switch gear 30 may switch between the transformer 22 (connection not depicted) and the UPS 28 to supply power to one or more mechanical systems 12, such as lighting and general air conditioning systems.

A UPS output switch 32 may be used to selectively provide power to a critical equipment switch 34 from the UPS 32 as needed and as available. The critical equipment switch 34 can selectively route power from either the transformer 22 (connection not depicted) or the UPS 32 to critical mechanical systems 14, such as primary air conditioning, backup lighting, security equipment, etc. The server 16 is also connected to the UPS output switch 32 and during normal operation the server will draw approximately 50% of its power from this power path.

An identical power path is shown on the right side of FIG. 1. The equipment in locations corresponding to the left side equipment perform the same functions and in the same proportions as their counterparts. The right side equipment includes a transformer 36, a generator 38, utility switch gear 40, a UPS 42, mechanical switch gear 44, a UPS output switch 46, and a critical equipment switch 48. Obviously, not every data center or server farm follows this exact configuration. Some may have more equipment, such as additional generators, others may have less equipment.

### SUMMARY

The prior art symmetric architecture has several shortcomings. One is cost. Since both sides of the architecture can support 100% of the power requirements of the entire system, a system capable of supporting 200% of the system power needs must be purchased, installed and maintained. A second shortcoming is the operating efficiency. Each side is essentially idling at 50% of its design capacity instead of operating at something closer to its target capacity. A third shortcoming is the reliability issues introduced by the failure of the protection equipment itself. In the power path, each piece of equipment and the connections to it have their own reliability issues and increase the likelihood of a power failure due exclusively to the equipment in place that is supposed to protect against a power interruption.

One additional, significant, shortcoming is the heat dissipation/power loss of the architecture. Every component of both power paths wastes energy in the form of generated heat. This heat loss not only consumes electric power intended for the destination equipment, e.g. servers and mechanical systems, but also requires additional air conditioning capacity and operating cost to remove this waste heat.

An asymmetric power path architecture feeds raw or lightly conditioned power on one path to meet close to 100% of the operating power requirements for a high availability environment. A second, fully backed up path, similar to one of the paths of the prior art architecture operates at a very low level as a standby source. Because little or no equipment is in the primary path, power loss, heat, and reliability issues are minimized. Because the full backup path operates at a very low level, heat loss is minimized and component lifetime is maximized, improving its reliability as well.

### BRIEF DESCRIPTION OF THE DRAWINGS

FIG. 1 is a block diagram of a prior art system for providing power to a high availability environment,

FIG. 2 is a block diagram of system for providing power to a high availability environment,

FIG. 3 is a block diagram of another embodiment of a system for providing power to a high availability environment, and

FIG. 4 is a flow chart of a method for providing power in a high availability environment.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

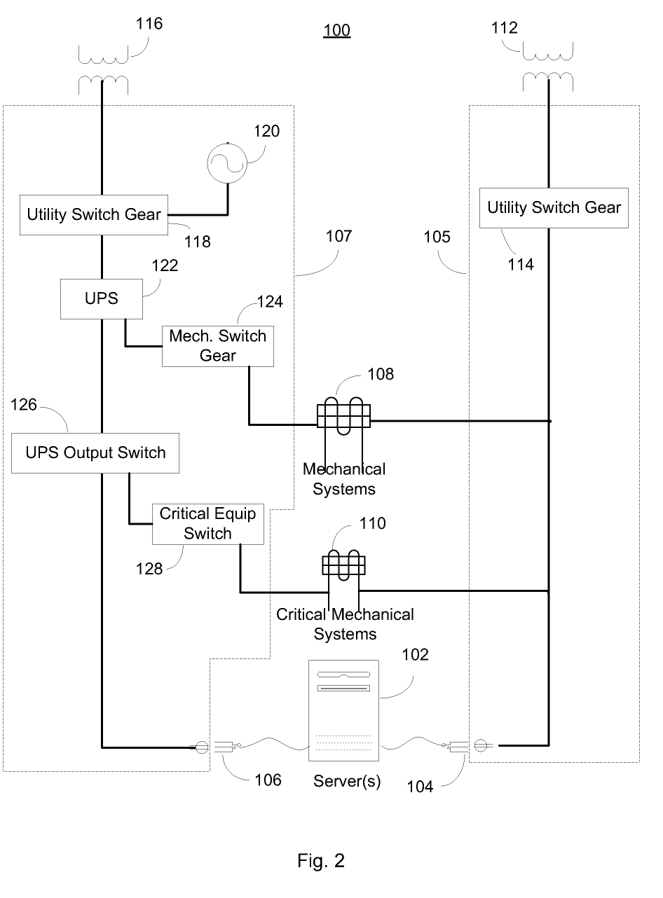

FIG. 2 illustrates an system for supplying power in a high availability environment, that is, an environment where equipment must receive a reliable supply of electrical energy, during any number of different supply power events, such as loss of power, spikes, brown-outs, etc. The high availability environment may support any of a number of information technology environments, such as a server, storage device, server rack, etc., or other high availability environment, for example, a clean room or communication or security facility/equipment. This architecture is particularly applicable to “two corded” systems that are capable of being directly connected to separate power supply paths.

A server 102, representing any high availability equipment, is shown with dual power cords 104 and 106, each cord capable of supporting up to 100% of the power needs of the server 102. As in the prior art embodiment, the total power needs of the server 102 may be shared between power cords 104 and 106 in any ratio.

Mechanical systems 108 may support the operation of the secure environment and may include air filters, air conditioning, lighting, etc. Critical mechanical systems 110 may include critical air conditioning, security functions, emergency lighting, etc. Power may supplied via two power paths, one power path 105, begins at transformer 112 and the other, power path 107, beginning at transformer 116. The power path 105 may include little or no conditioning. In this exemplary embodiment, only utility switch gear 114 is included. The utility switch gear 114 may be used to isolate transformer 112 from its various loads, for example, if the power from transformer 112 becomes noisy or off-voltage. The utility switch gear 114 may supply power directly to the server 102 and both the regular and critical mechanical systems 108 and 110, respectively.

The power path 107 may include more traditional power conditioning. For example, in this exemplary embodiment, may include utility switch gear 118 that can selectively connect power from transformer 116 or generator 120. An uninterruptible power supply (UPS) 122 may provide power when power is not available from either the transformer 116 or the generator 120, as may occur when an outage occurs at the transformer 116 and before the generator 120 can be brought on line. As in the prior art implementation, the mechanical switch gear 124 and critical equipment switch gear 128 can be used to connect back up power from the generator 120 or UPS 122 when main power 116 is not available (connection not depicted). A UPS output switch 126 may further isolate the server 102 as required, or allow connection of additional conditioned sources (not depicted).

In one exemplary embodiment, 90% or more of the power may be supplied by the power path 105 during normal operation. Because each piece of equipment in both power paths has a certain amount of power loss, especially the active components such as the UPS, when fewer components are present, the more energy efficiency will result. As such, the power path 105 will have a substantially greater energy efficiency than power path 107. In this respect, the power path 105 may be considered a “green” path, that is, more environmentally friendly, because it reduces power wasted both in generating less heat in the green power path 105 and using less energy to cool the green power path 105. Supplying more power via the power path 105 will result in greater efficiency, that is, less wasted energy, than if power were supplied equally between the two power paths 105 and 107. Also, because fewer components are present, reliability will be higher and initial installation cost will be lower, and as mentioned, will require less cooling. In short, overall lifetime cost of ownership is reduced while the ability to supply power on a high availability basis is substantially maintained, especially in environments where power incidents are rare to begin with, such as some urban areas.

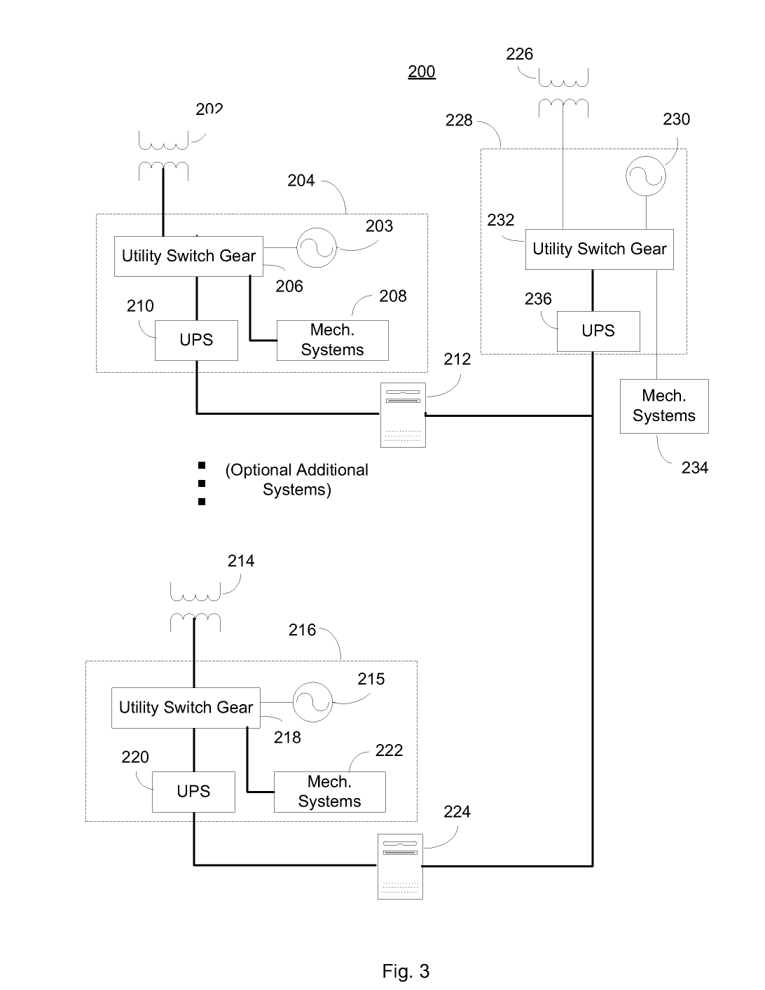

FIG. 3 illustrates another embodiment of an asymmetric power supply architecture for high availability environments. In this embodiment, multiple loads 212 and 224 (or more) each have separate primary power paths 204 and 216, respectively, and share a common backup power path 228. Each primary power path includes a transformer 202 and 214 and switch gear 206 and 218 supplying power to respective mechanical systems 208 and 222. Each primary power path has a UPS 210 and 220 and may include a generator 203 and 215. As above, the loads 212 and 224 are “two-corded,” that is, capable of operating from either of two sources of power. In some embodiments a ratio of five primary systems to one back up system may be employed.

The backup power path 228 may include a generator 230, switch gear 232, a UPS 236 and mechanical systems 234. The mechanical systems 234 may be separate from the primary mechanical systems 208 and 222, or may simply represent a power connection to the primary systems 208 and 222. Because each primary and the backup power paths are essentially symmetrical, the backup path can fully supply any single load that experiences a power interruption on its primary path. The assumption is that multiple failures in the primary paths are unlikely, as may be determined by broader circumstances, such as past history, likelihood of natural disaster, etc. However, as shown in FIG. 3, in the event of a widespread outage, each load 212 and 224 (or more) would have to rely primarily on its respective UPS and generator 210/203 and 220/215, although the backup power path 228 could supply some portion of the power to the loads 212 and 224. In this embodiment, initial equipment costs are lowered and operating losses due to operation of fully redundant dual feed mechanisms are avoided.

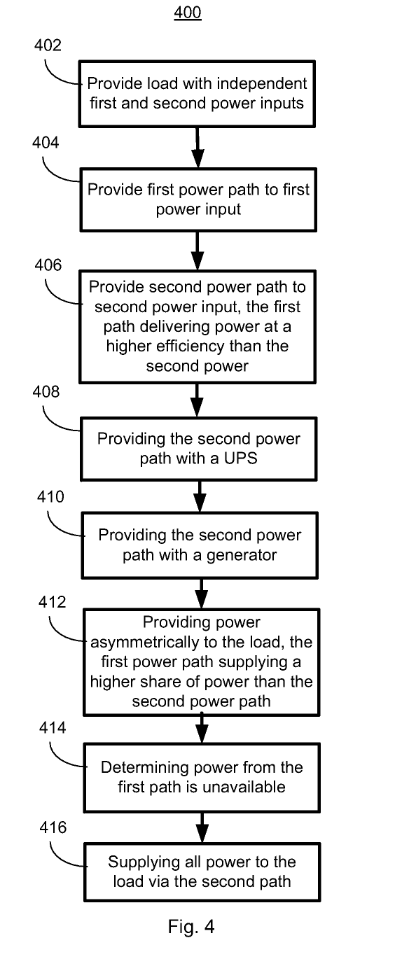

FIG. 4 is a flow chart of an exemplary method 400 of supplying power in a high availability environment. At block 402, a load 102 is provided, the load 102 having separate and independent first 104 and second 106 electrical power inputs. The load 102 may be one or more servers, security equipment, medical equipment, etc, for which it is desirable to maintain power. At block 404, a first electrical power path 105 is provided that connects a first utility connection via transformer 112 to the first electrical power input 104, the first electrical power path supplying more than 90% of the electrical power needs of the load 102 via the first electrical power input 104.

At block 406, a second electrical power path 107 may be provided connecting a second utility connection via transformer 116 to the second electrical power input 106. The first electrical power path 105, because it has fewer components, may deliver electrical power at a higher efficiency than the second electrical power path 107. For this example, efficiency may be defined as a ratio of electrical power delivered at the respective first and second electrical power inputs 104, 106 of the load 102 divided by the electrical power delivered by the respective utility connections, e.g. at transformers 112 and 116.

At block 408, the second electrical power path may be provided with an uninterruptible power supply (UPS) 122. At block 410, the second electrical power path 107 may be provided with a generator, to provide power when such power is not available at the second transformer 116.

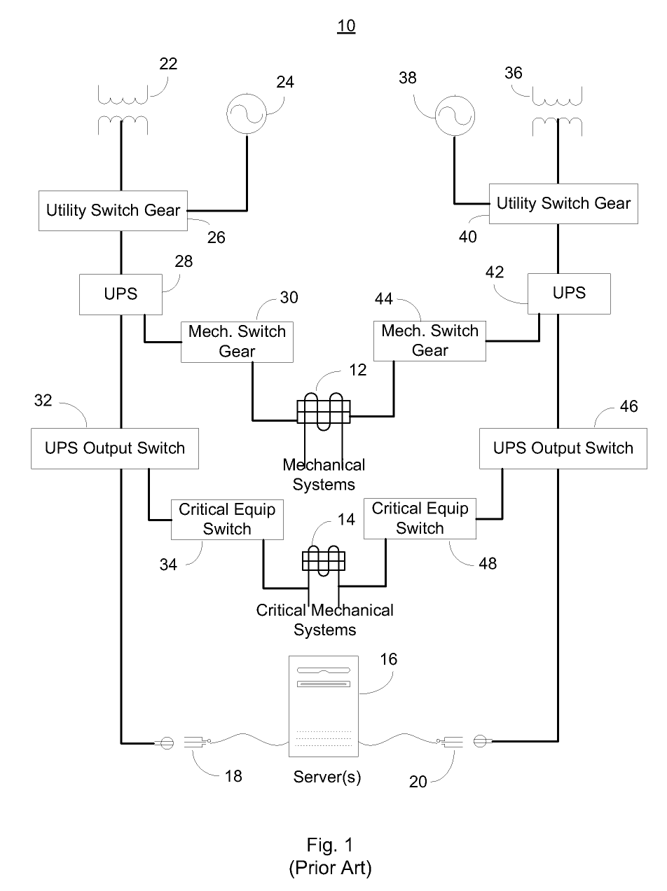

At block 412, the system 100 may be operated asymmetrically, such that the second electrical power path 107 supplies less than 10% of the electrical power needs of the load 102 during normal operation, that is, when power from both sources is available. During operation, because the first electrical power path 105 has both a greater inherent efficiency than the second power path 107 and because the first power path 105 delivers a greater percentage of the power to the load 102, the overall efficiency of the system 100 is improved over a symmetrical power delivery system, such as that of FIG. 1.

At block 414, it may be determined that power from one source is not available. At block 416, when power is not available from one source, the other source may supply 100% of the power needs of the load. For example, after determining that electrical power is unavailable via the first electrical power path 105, 100% of the electrical power needs of the load 102 may be supplied to the second electrical power input 106 via the second power path 107.

This elegant, but simple, architecture acknowledges that may locales have mature power delivery infrastructure and that the quality of the power and the availability are quite good. In such environments, a significant cost savings can be realized by the asymmetric architectures disclosed above, by lowering initial installation costs and by improving overall operating efficiency, and in some cases, improving reliability by removing backup components and their own associated failure rates.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A system for supplying high availability power to a load, the system comprising:
the load with at least a first power input and a second power input;
a conditioned power source supplying power to the first power input; and
a green power source supplying a greater portion of power to the second power input than the conditioned power source supplies to the first power input, whereby either the conditioned power source or the green power source supplies 100% of the power to the load upon a failure of the other power source.

2. The system of claim 1, wherein the green power source supplies power from a utility to the load at a higher efficiency than the conditioned power source.

3. The system of claim 2, wherein the green power source includes a switch between the utility and the load, the switch providing unconditioned power to the load.

4. The system of claim 3, wherein the green power source supplies greater than 90% of the power required by the load in normal operating conditions.

5. The system of claim 4, wherein the conditioned power source includes an uninterruptible power supply (UPS).

6. The system of claim 5, wherein the conditioned power source includes a generator.

7. The system of claim 6, wherein the conditioned power source supplies 100% of the power to the load when the green power source is unable to supply any power.

8. The system of claim 5, wherein the conditioned power source supplies 100% of the power to the load when the green power source is unable to supply any power.

9. A method of supplying electrical power to a load that consumes electrical power, comprising:
providing the load, the load having separate and independent first and second electrical power inputs;
providing a first electrical power path connecting a first utility connection to the first electrical power input, the first electrical power path supplying more than 90% of the electrical power needs of the load to the first electrical power input;
providing a second electrical power path connecting a second utility connection to the second electrical power input, the second electrical power path supplying less than 10% of the electrical power needs of the load to the second electrical power input, the first electrical power path delivering electrical power at a higher efficiency than the second electrical power path, efficiency being a ratio of electrical power delivered at the respective first and second electrical power inputs of the load divided by the electrical power delivered by the respective utility connection;
operating the first electrical power path to have a higher delivered electrical power efficiency than the second electrical power path; and
determining that electrical power is unavailable via the first electrical power path and supplying 100% electrical power of the needs of the load to the second electrical power input via the second power path.

10. The method of claim 9, wherein providing the second power path comprises providing the second power path including an uninterruptible power supply (UPS).

11. The method of claim 9, wherein providing the second power path comprises providing the second power path including a generator.

12. The method of claim 9, wherein providing the second power path comprises providing the second power path including a generator and an uninterruptible power supply.

13. A system for providing power to a plurality of loads, each load having multiple power inputs, the system comprising:
a plurality of primary power sources, one primary power source for each of the plurality of loads, each primary power source coupled to a respective first power input of each of the plurality of loads;
a single shared power source directly coupled to respective second power inputs of each of the plurality of loads, wherein the single shared power source supplies power to any single load when its primary power source fails.

14. The system of claim 13, wherein each primary power source and the secondary power source are symmetrical and all include an uninterruptible power supply (UPS).

15. The system of claim 13, wherein each primary power source and the secondary power source are symmetrical and all include a UPS and a generator.
